(19) United States
(12) Patent Application Publication
(10) Pub. No.: US 2017/0370284 A1
(43) Pub. Date: Dec. 28, 2017

(54) GAS TURBINE ENGINE

(71) Applicant: ROLLS-ROYCE plc, London (GB)

(72) Inventors: Giles E. HARVEY, Derby (GB); Glenn A. KNIGHT, Derby (GB)

(73) Assignee: ROLLS-ROYCE plc, London (GB)

(21) Appl. No.: 15/602,429

(22) Filed: May 23, 2017

(30) Foreign Application Priority Data
Jun. 22, 2016 (GB) 1610877.1

(51) Int. Cl. F02C 3/04; F01D 9/02; F02C 7/36; F02K 3/06

(52) U.S. Cl. CPC F02C 3/04; F02K 3/06; F01D 9/023; F02C 7/36

(57) ABSTRACT

A gas turbine engine (10) comprises:
a low pressure compressor (18) comprising a centrifugal compressor stage (24);
a low pressure turbine (44) configured to drive a load (12), the low pressure turbine (44) being provided rearwardly of the low pressure compressor (18);
a high pressure turbine (42) provided rearwardly of the low pressure turbine (44);
a combustor (40) provided rearwardly of the high pressure turbine (42);
a high pressure compressor (32) provided rearwardly of the combustor (40); and
an intercooler heat exchanger (28) configured to exchange heat between core airflow (B) exiting the low pressure compressor (18) and fan airflow (A), wherein the high pressure turbine (42) and high pressure compressor (32) are coupled by a high pressure shaft (46), and the low pressure turbine (44), low pressure compressor (18) and load (12) are coupled by a low pressure shaft (22).

The present disclosure concerns a gas turbine engine.

There is a continual need to both increase the fuel efficiency of gas turbine engines, and reduce their cost. One known technology for at least increasing fuel efficiency is to employ a reduction gearbox between a fan and a fan drive turbine, such that the fan can be operated at a lower rotational speed than the fan drive turbine. One such engine is described in U.S. Pat. No. 8,176,725, which describes a gas turbine engine having a fan drive gear system, a low spool connected to the fan drive gear system, and a high spool disposed aft of the low spool. The low spool comprises a rearward-flow low pressure compressor disposed aft of the fan drive gear system, and a forward-flow low pressure turbine disposed aft of the low pressure compressor. The high spool comprises a forward-flow high pressure turbine disposed aft of the low pressure turbine, a combustor disposed aft of the high pressure turbine, and a forward-flow high pressure compressor disposed aft of the combustor. The engine comprises a heat exchanger configured to exchange heat between the compressed air in the core, and the fan flow, to thereby provided intercooling.

The present invention seeks to provide an improved gas turbine engine, which has high fuel efficiency, and low cost.

According to a first aspect of the invention there is provided a gas turbine engine comprising:

a low pressure module comprising a low pressure compressor comprising a centrifugal compressor stage, and a low pressure turbine configured to drive a load
a high pressure module comprising a high pressure turbine, a combustor and a high pressure compressor, the high pressure module being provided axially spaced from the low pressure module; and
an intercooler heat exchanger configured to exchange heat between core airflow exiting the low pressure compressor and ambient airflow, wherein the high pressure turbine and high pressure compressor are coupled by a high pressure shaft, and the low pressure turbine, low pressure compressor and load are coupled by a low pressure coupling.

Advantageously, the above arrangement provides a gas turbine engine which is thermally efficient, compact and low cost.

The load driven by the low pressure turbine may comprise a fan. The fan may define a forward end of the engine, and may be provided forwardly of the low pressure turbine. The fan may be configured to provide a fan outlet flow in a rearward direction. The high pressure compressor may be configured to transfer flow in a forward direction generally opposite to the rearward direction. Alternatively, the high pressure compressor may be configured to transfer flow in a radially outward or inward direction.

The combustor may be configured to receive core flow from the high pressure compressor, and deliver flow from a compressor outlet in the forward direction.

The high pressure turbine may be configured to receive flow from the combustor and deliver flow to the low pressure turbine.

The low pressure turbine load may be coupled to the low pressure turbine by a reduction gearbox. The reduction gearbox may be provided between the low pressure compressor and the load. The low pressure turbine may be provided between the combustor and the low pressure compressor.

The high pressure compressor may comprise one or both of at least one axial flow compressor stage and at least one centrifugal flow compressor stage.

The low pressure compressor may comprise a single stage centrifugal impellor. The low pressure compressor may further comprise an axial flow compressor upstream of the centrifugal flow compressor, and coupled to the low pressure shaft.

The engine may comprise an interstage duct extending between a low pressure compressor outlet and a high pressure compressor inlet. The intercooler heat exchanger may comprise the interstage duct. The interstage duct may be provided radially outwardly of the high pressure compressor and high pressure turbine.

The engine may comprise a core exhaust duct configured to redirect core exhaust from a low pressure turbine outlet in the rearward direction. The core exhaust duct may terminate downstream of the interstage duct. The interstage duct and core exhaust duct may extend generally parallel to one another. A plurality of core exhaust ducts and interstage ducts may be provided, and may be arranged alternately with one another, and may be circumferentially spaced around the engine.

The engine may comprise a bypass ratio of 10 or greater.

The skilled person will appreciate that except where mutually exclusive, a feature described in relation to any one of the above aspects of the invention may be applied mutatis mutandis to any other aspect of the invention.

Embodiments of the invention will now be described by way of example only, with reference to the Figures, in which:

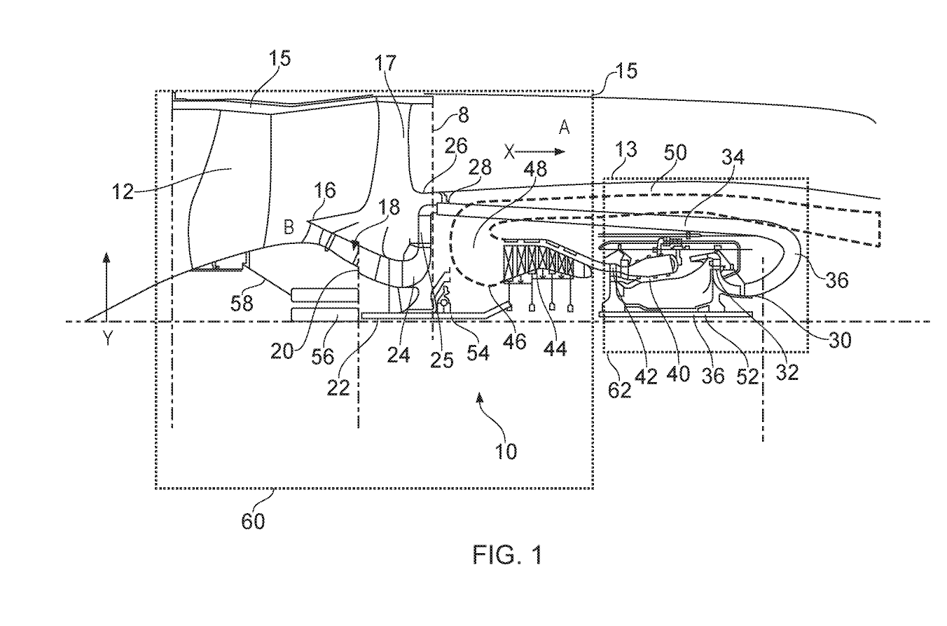

FIG. 1 is a sectional side view of a first gas turbine engine in accordance with the present invention;

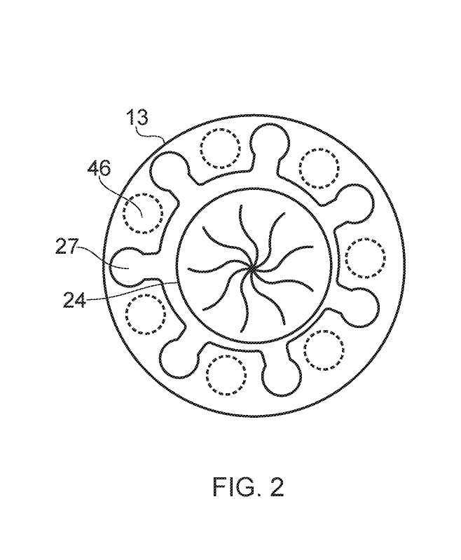

FIG. 2 is a sectional frontal view of the gas turbine of FIG. 1 along the line 8; and

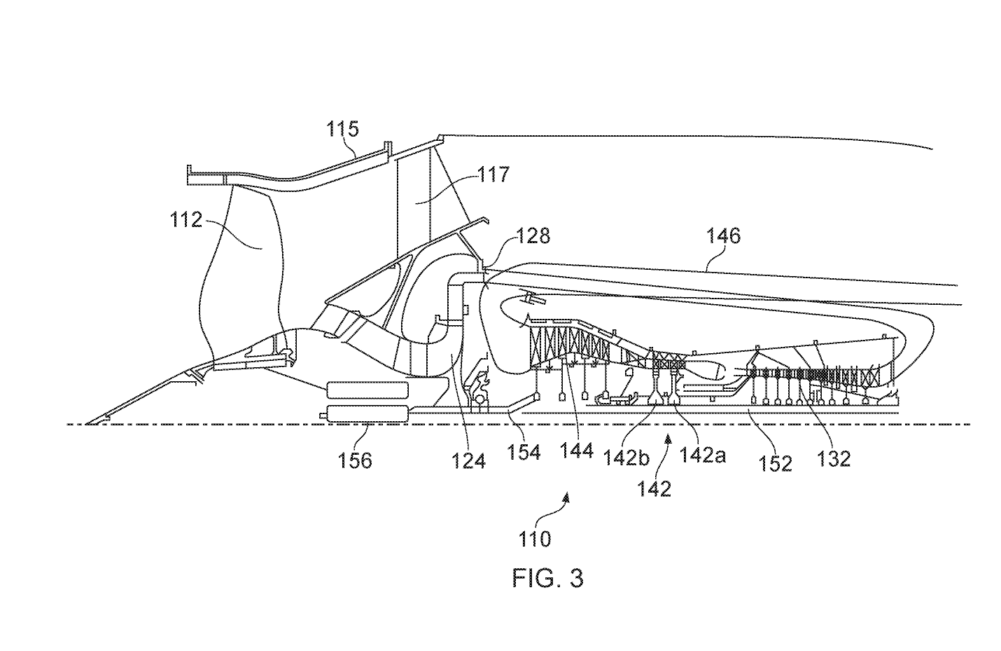

FIG. 3 is a sectional side view of a second gas turbine engine in accordance with the present invention; and

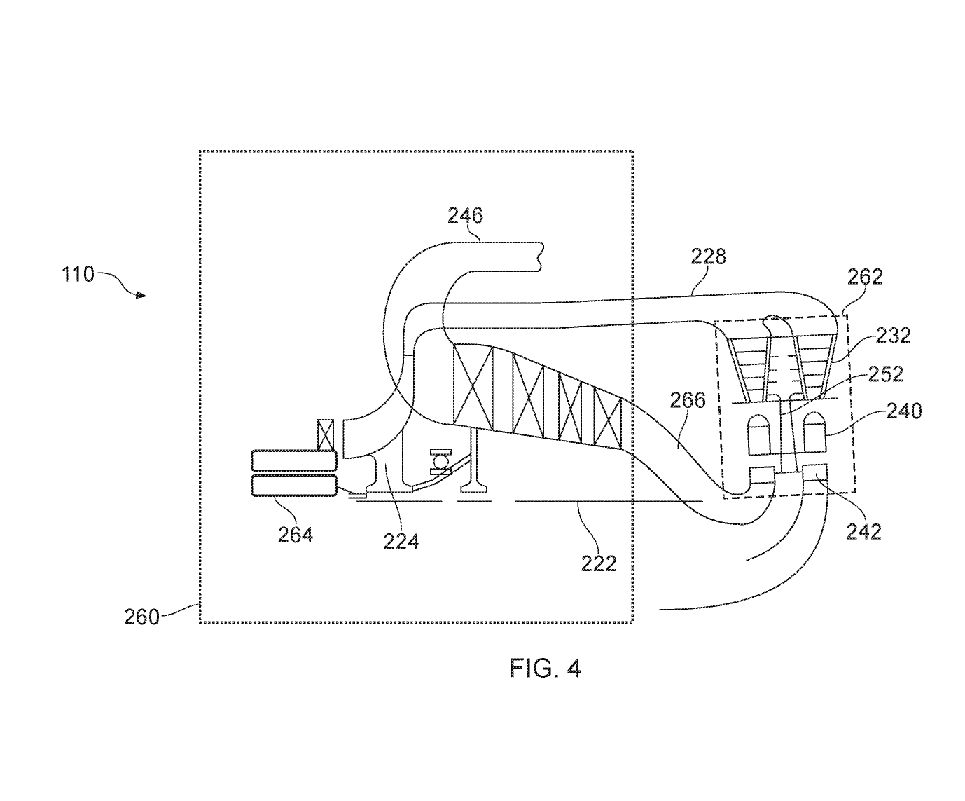

FIG. 4 is a sectional side view of a third gas turbine engine in accordance with the present invention.

With reference to FIG. 1, a gas turbine engine 10 comprises a low pressure module 60 comprising a low pressure turbine 44, low pressure compressor 24 and load in the form of a fan 12 interconnected by a low pressure coupling comprising a low pressure shaft 22, reduction gearbox 56 and fan shaft 58. The fan 12 is configured to accelerate air entering an engine inlet 14 and provide a fan bypass flow A and core flow B, both of which flow initially in a first axial direction X. The fan 12 defines a forward end of the engine, and so the first axial direction defines a rearward direction, with a forward direction being defined by a direction opposite (i.e. 180°) to direction X. Rearwardly, and downstream in bypass flow A of the fan 12 is an outlet guide vane 17, which straightens the flow from the fan 12, and supports an engine core. Also downstream of the fan 12 is a core engine inlet 16 which diverts part of the fan flow into the core. The core (comprising compressors 18, 32, combustor 40 and turbines 42, 44, described in further detail below) is housed within a generally annular core nacelle 13. The fan 12 is housed within a generally annular fan nacelle 15, which extends axially downstream of the fan 12, and is driven by a low pressure fan drive turbine 44 via a gearbox 56. The fan flow A is defined by the region bounded by the nacelles 13, 15. A bypass ratio is defined by the ratio between the mass flow rate of air drawn through the fan disk that bypasses the engine core (bypass flow A) to the mass flow rate passing through the engine core (core flow B). In the described embodiments, the engine has a bypass ratio of approximately 10.

The engine 10 further comprises a high pressure module 62 comprising, in flow series, a high pressure compressor 32, combustor 40, and high pressure turbine 42. The high pressure compressor 32 and high pressure turbine 42 are coupled by a high pressure shaft 36. The high pressure module 62 and low pressure module 60 are axially spaced, i.e. their respective axes do not overlap.

Downstream in core flow B of the core inlet 16 is the low pressure compressor 18. The low pressure compressor comprises a single stage axial flow compressor comprising a rotor 20 and stator 22. Downstream of the stator 22 is a centrifugal compressor stage comprising an impellor 24 and diffuser 25, which further compresses the core airflow B. The centrifugal compressor impellor 24 is of conventional construction, and is arranged to ingest air provided to the centrifugal compressor from the axial direction X, and expel air at an outlet 26 in a generally radial direction Y, through the diffuser 25. Centrifugal compressors generally have a higher stage ratio than axial compressors, and so a single rotor component can raise the pressure to a greater degree than an axial compressor in a given length. However, centrifugal compressors must either operate at high speeds, or have a large tip diameter in order to operate efficiently. In addition, the diffuser 25 generally increases the diameter still further. Consequently, the centrifugal compressor has a relatively large diameter compared to other rotor components of the gas turbine engine. In particular, the centrifugal compressor outlet has a larger radial extent than the final stage of the low pressure turbine 44. In particular, the tip of the centrifugal impellor 24 has a greater radius than the tips of the rotor blades of the low pressure turbine 44.

The outlet 26 of the centrifugal compressor impellor stage (i.e. the diffuser 25) provides core airflow B to an intercooler in the form of an interstage duct 28. The interstage duct 28 carries compressed core airflow B from the outlet 26 of the centrifugal compressor 24 to an inlet 30 of a high pressure centrifugal compressor 32. An intermediate portion 34 of the duct 28 extends in a generally axial direction, and carries core airflow B in the axial direction X. The intermediate portion 34 is located in thermal contact with the core nacelle 13, and so the intermediate portion acts as a parallel flow heat exchanger, exchanging heat between the relatively hot compressed core flow B with the relatively cool fan flow A. Fins, turbulators or other flow control devices may be provided within the intermediate portion 34 and/or on an outer surface of the core nacelle 13 to increase the surface area of the intercooler heat exchanger hot and/or cold sides, and thereby facilitate heat exchange.

A downstream end of the interstage duct 28 comprises an elbow connector 36 which is configured to turn the core airflow B approximately 180° from being generally parallel to the axial flow direction X, to counter to the axial flow direction X for ingestion into the inlet 30 of the high pressure centrifugal compressor 32. The high pressure centrifugal compressor 32 again comprises a centrifugal impellor and diffuser configured to raise the pressure of the core airflow B by redirecting the air from generally counter to the axial flow direction X, to the generally radial direction Y. The high pressure centrifugal compressor 32 has a smaller diameter than the low pressure impellor 24, as the high pressure impellor rotates at a higher speed in use.

An outlet 36 of the high pressure compressor 32 delivers air to an inlet of the combustor 40, which adds fuel to the core airflow B, to thereby burn the fuel and increase the temperature of the core airflow B. A high pressure turbine 42 is provided downstream of the combustor 40, which is acted upon by the core airflow B to thereby drive the turbine 42. The turbine in the described embodiment comprises a single stage axial flow rotor, though multi stage or centrifugal flow rotors could be employed.

The low pressure turbine 44 is provided downstream in core flow B of the high pressure turbine 42. The low pressure turbine 44 generally comprises a plurality of axial flow turbine rotors and interposed stators.

A core exhaust duct 46 is provided downstream of an outlet of the low pressure turbine 44. The core exhaust comprises an elbow 48 at an upstream portion, which is configured to redirect the forward flow from the low pressure turbine 44 outlet 180° and radially outwardly, to the axial, rearward direction X. An intermediate portion 48 extends from the elbow 48 in the axial direction X, and exhausts the core airflow at an aft end of the engine. As can be seen from FIG. 1, the intermediate portions 34, 48 of the interstage duct 28 and core exhaust duct 46 extend in the axial direction at substantially the same radial position. Consequently, a plurality of interstage and core exhaust ducts 28, 46 are arranged alternately around the circumference of the engine core casing 13, as shown in FIG. 2. The engine exhaust duct 46 is generally spaced from both the interstage duct 28 and engine core casing 13 and may also be insulated to avoid heating either the fan flow A or the core flow B within the interstage duct 28.

The high pressure compressor 32 and turbine 42 are coupled by a high pressure fan drive shaft 52. Consequently, the high pressure compressor 32 is driven by the turbine 42 via the shaft 52. The low pressure turbine 44 and low pressure compressor 24 are coupled by a low pressure shaft 54, and so the low pressure compressor 24 is driven by the low pressure turbine 44 via the low pressure shaft 54. The low pressure shaft 54 is also coupled to a reduction gearbox 56, which is in turn coupled to the fan 12 via a fan shaft 58. The reduction gearbox is configured to provide a reduction ratio of at least 2.5:1. Consequently, the fan 12 is driven by the low pressure turbine 44, but the fan 12 rotational speed is different from the turbine 44 rotational speed. Consequently, the fan drive low pressure turbine 44 can rotate at a relatively high speed compared to conventional high pressure ratio fan gas turbine engines, and so the low pressure turbine can have a smaller diameter. Consequently, the radius of curvature of the core flow exhaust elbow 48 can be relatively large, without resulting in an excessively large diameter engine core.

The engine 10 is consequently arranged as follow. The fan 12 is located at an axially forward end of the engine 10, with the reduction gearbox 56 provided at the same axial position, or rearwardly thereof. The low pressure compressor 18 is provided rearwardly of the fan 12 and gearbox 56. The core exhaust elbow 48 is provided rearwardly of the low pressure compressor 24, and the low pressure turbine 44 is provided axially rearwardly of both the elbow 48 and the low pressure compressor 24. The low pressure shaft 54 extends between a forward end of the low pressure turbine 44 and the gearbox 56. Consequently, the low pressure shaft 54 is relatively short, which reduces engine weight, and reduces shaft whirling.

The high pressure turbine 42 is provided rearwardly of the low pressure turbine 44, with the combustor 40 being provided further rearwardly, followed by the high pressure compressor 32 still further rearwardly, and the interstage duct elbow 36 is provided at the rear of the engine 10. The high pressure shaft 52 extends between the high pressure turbine 32 and high pressure compressor 32, through the combustor 40, and so is again relatively short. Since the modules 60, 62, and so the shafts 52, 54 are axially spaced, they do not have to be arranged concentrically, which simplifies bearing and oil design. Furthermore, the engine 10 can be modular, with the high pressure compressor 32 and turbine 42 of the engine core being removeable from the remainder of the engine, without having to remove the low pressure section (i.e. the low pressure turbine 44, compressor 18, gearbox 56 and fan 12).

In general, reverse flow architecture cores require relatively large diameter cores, particularly at their mid-sections, since the low pressure turbine generally requires a large number of large diameter stages, and this is located relatively forward within the engine core nacelle 13 in a reverse flow architecture. This large diameter is exacerbated by the requirement for an exhaust duct 46 which turns the flow 180° to be exhausted in the axial direction X. The turning of the flow also results in aerodynamic inefficiency within the exhaust duct, which in turn results in higher backpressure at the low pressure turbine exhaust, resulting in lower turbine efficiency, and so lower overall cycle efficiency or increased turbine stage count. This can be ameliorated by increasing the radius of curvature of the exhaust duct elbow 48, but results in a still larger diameter engine core.

These advantages and disadvantages are thought to largely cancel one another in conventional reverse flow architectures, such that significant benefits cannot be achieved, particularly in large, high bypass ratio engines.

The current invention overcomes these limitations by utilising the large diameter low pressure centrifugal compressor impellor 24, in place or in addition to a conventional axial flow low pressure compressor 20. Centrifugal compressors generally have higher efficiencies (both in terms of stage pressure rise and thermodynamic efficiency) where there tip speed is high. This can be achieved by providing a large diameter rotor, or be rotating at high speeds. In the present invention, the large diameter core provides an opportunity to provide a high efficiency centrifugal compressor, which can efficiently develop a high pressure ratio. The resultant engine has further weight and cost savings, which would be expected to outweigh the above disadvantages. Furthermore, in view of the desirability of a high rotational speed for the centrifugal compressor 24, the rotational speed of the low pressure turbine 44 can also be increased, which may result in fewer turbine stages being required for a given power, or a reduced diameter. This could in turn be used to reduce the diameter of the core engine, or increase the radius of curvature of the exhaust duct elbow 48, thereby further resolving the above disadvantages.

The reduction gearbox 56 also provides distinct advantages in combination with other features of the invention, in that the turbine speed can be increased, without requiring an increase in fan rotational speed. Such an advantage is particularly desirable in high bypass turbofans, since the resultant high tip speeds in a directly driven high speed fan would otherwise result in high noise levels and reduced efficiency.

FIG. 3 shows a second gas turbine engine 110 in accordance with the present disclosure. The second gas turbine engine 110 is similar in many respects to the gas turbine engine 10 of FIGS. 1 and 2, and comprises a fan 112 configured to provide a fan bypass flow A and core flow B, both of which flow initially in a first axial direction X. Downstream of the fan 112 is an outlet guide vane 117, which straightens the flow from the fan 112. Also downstream of the fan 112 is a core engine inlet 116 which diverts part of the fan flow into the core. The core (comprising compressors 118, 132, combustor 140 and turbines 142, 144) is housed within a generally annular core nacelle 113. Low pressure turbine 144 is coupled to the low pressure compressor 124 by a low pressure shaft 154 which is in turn coupled to the fan 112 by a reduction gearbox 156, and the high pressure turbine 142 is coupled to the high pressure compressor 132 by a high pressure shaft 152. The fan 112 is housed within a generally annular fan nacelle 115, which extends axially downstream of the fan 112. The fan flow A is defined by the region bounded by the nacelles 113, 115. Again, the engine has a bypass ratio of approximately 10. Again, the high pressure compressor 132, combustor 140, and high and low pressure turbines 142, 144 are reverse flow, while the fan 112 and low pressure compressor 124 are of conventional flow, providing flow in the aft direction X. Ducts 128, 146 similar to the ducts 28, 46 are provided.

The core and fan 112 are similar to that of the engine 10, but the high pressure compressor 132 and turbine 142 differ to those of the engine 10. The high pressure compressor 132 is of axial type, having a plurality of axial compressor stages, each stage comprising a rotating compressor rotor comprising a plurality of compressor blades, and a compressor stator comprising a plurality of stationary stator blades. The rotors are driven by the high pressure turbine 142. The high pressure turbine 142 is of axial type, and has first 142a and second 142b stages, such that increased power can be provided to the high pressure compressor. Consequently, the high pressure compressor 132 may be capable of generating a higher compression ratio than the high pressure compressor 32 of the engine 10 at the cost of increased engine length. However, the length of the high pressure shaft 152 is substantially unaffected, since the high pressure shaft 152 extends between a forward end of the high pressure compressor 132 and an aft end of the high pressure turbine 142.

FIG. 4 shows a third gas turbine engine 210. The third gas turbine engine 210 is similar in many respects to the gas turbine engine 10 of FIGS. 1 to 3, and again comprises a low pressure module 260 comprising a low pressure turbine 244, low pressure compressor 224 and load in the form of an electrical generator 264 interconnected by a low pressure coupling comprising a low pressure shaft 222. The engine further comprises a high pressure module 262 comprising, in flow series, a high pressure compressor 232, combustor 240, and high pressure turbine 242. The high pressure compressor 232 and high pressure turbine 242 are coupled by a high pressure shaft 236. The high pressure module 262 and low pressure module 260 are axially spaced, i.e. their respective axes do not overlap

A core engine inlet is provided 216 which ingests airflow into the core. An intercooler duct 228 is provided, which again cools air between the low and high pressure compressors 224, 232, as ambient air flows thereover. A fan may be provided to blow cold ambient air over the intercooler ducting 228.

The high pressure shaft 236 is arranged to rotate about an axis generally perpendicular to a rotational axis of the low pressure shaft 222 and fan shaft 258. An inlet 230 to the high pressure compressor 232 is provided at a radially outer end of the compressor 232, with the compressor 232, combustor 240 and high pressure turbine 242 being configured to direct air radially inwardly. Downstream of the high pressure turbine 242, a duct 266 is provided to direct air forwardly toward an inlet of the low pressure turbine 244, before it is exhausted through an exhaust duct 246. Consequently, less bending is required relative to the embodiments shown in FIGS. 1 to 3. Such an arrangement is particularly suitable for a land or ship based application, in which engine diameter is of less importance. Alternatively, the generator 264 could be replaced by a gearbox driving a helicopter rotor blade in a helicopter application.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

For example, the bypass ratio could be altered. The turbines and compressors could have different numbers of stages. The gearbox may have a different reduction ratio, or may be of a different arrangement. The gearbox could be omitted in some cases.

Though the load driven by the low pressure turbine is in the form of a fan, it will be understood that the load could alternatively comprise one or more of an electrical generator, a marine propeller, or any other suitable load.

It will be understood that the high pressure shaft could be provided having substantially any rotational axis relative to the low pressure shaft.

1. A gas turbine engine comprising:
a low pressure module comprising a low pressure compressor comprising
a centrifugal compressor stage, and a low pressure turbine configured to drive a load
a high pressure module comprising a high pressure turbine, a combustor and a high pressure compressor, the high pressure module being provided axially spaced from the low pressure module; and
an intercooler heat exchanger configured to exchange heat between core airflow exiting the low pressure compressor and ambient airflow, wherein the high pressure turbine and high pressure compressor are coupled by a high pressure shaft, and the low pressure turbine, low pressure compressor and load are coupled by a low pressure coupling.

2. A gas turbine engine according to claim 1, wherein the load driven by the low pressure turbine comprises a fan configured to provide a fan outlet flow in a rearward direction.

3. A gas turbine engine according to claim 2, wherein the fan is provided forwardly of the low pressure turbine.

4. A gas turbine engine according to claim 1, wherein the high pressure compressor is configured to transfer flow in a forward direction generally opposite to the rearward direction.

5. A gas turbine engine according to claim 1, wherein the combustor is configured to receive core flow from the high pressure compressor, and deliver flow from a compressor outlet in the forward direction.

6. A gas turbine engine according to claim 1, wherein the high pressure turbine is configured to receive flow from the combustor and deliver flow from to the low pressure turbine.

7. A gas turbine engine according to claim 1, wherein the low pressure turbine load is coupled to the low pressure turbine by a reduction gearbox.

8. A gas turbine engine according to claim 7, wherein the reduction gearbox is provided between the low pressure compressor and the load.

9. A gas turbine engine according to claim 1, wherein the low pressure turbine is provided between the combustor and the low pressure compressor.

10. A gas turbine engine according to claim 1, wherein the high pressure compressor comprises one or both of at least one axial flow compressor stage and at least one centrifugal flow compressor stage.

11. A gas turbine according to claim 1, wherein the low pressure compressor further comprises an axial flow compressor upstream of the centrifugal flow compressor, and coupled to the low pressure shaft.

12. A gas turbine engine according to claim 1, wherein the intercooler heat exchanger comprises an interstage duct extending between a low pressure compressor outlet and a high pressure compressor inlet.

13. A gas turbine engine according to claim 12, wherein the interstage duct is provided radially outwardly of the high pressure compressor and high pressure turbine.

14. A gas turbine engine according to claim 13, wherein the engine comprises a core exhaust duct configured to redirect core exhaust from a low pressure turbine outlet in the first rearward direction, wherein the interstage duct and core exhaust duct may extend generally parallel to one another.

15. A gas turbine engine according to claim 14, wherein a plurality of core exhaust ducts and interstage ducts are arranged alternately with one another, and are circumferentially spaced around the engine.

16. A gas turbine engine according to claim 1, wherein the engine comprises a bypass ratio of 10 or greater.
